(19) United States
(12) Patent Application Publication
(10) Pub. No.: US 2025/0282933 A1
(43) Pub. Date: Sep. 11, 2025

(54) PARTICLES WITH A POLYMER COATING, PROCESS FOR PRODUCING THESE COATED PARTICLES AND THEIR USE

(71) Applicant: Gebrüder Dorfner GmbH & Co. Kaolin- und Kristallquarzsand-Werke KG, Hirschau (DE)

(72) Inventors: Andreas FROHMANN, Schnaittenbach (DE); Vanessa COLELLI, Amberg (DE); Maximilian DOBMEIER, Hahnbach (DE); Tobias MAAHSEN, Amberg (DE); Marco SÜß, Neunburg v. Wald (DE)

(21) Appl. No.: 19/068,867

(22) Filed: Mar. 3, 2025

(30) Foreign Application Priority Data
Mar. 5, 2024 (DE) 10 2024 106 341.6
Feb. 20, 2025 (DE) 10 2025 106 538.1

(51) Int. Cl. C08K 9/08; B05D 5/00; C08F 26/02; C08K 3/36

(52) U.S. Cl. CPC C08K 9/08; B05D 5/00; C08F 26/02; C08K 3/36; C08K 2201/005

(57) ABSTRACT

The present invention relates to particles having a surface coating which is hydrophobic at least in sections, comprising carrier particles which are surface-coated at least in sections with a coating composition based on type A monomers, wherein the type A monomers are a substance of the structure,

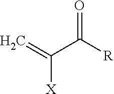

wherein R is selected from a group comprising OR¹, NR¹, NR¹R² and CN. The invention further relates to a method for producing such particles and a formed component comprising such particles.

### CROSS-REFERENCE TO RELATED APPLICATIONS

The instant application claims priority to German patent application no. 10 2024 106 341.6, filed Mar. 5, 2024, and German patent application no. 10 2025 106 538.1, filed Feb. 20, 2025, which are incorporated by reference herein to the extent that there is no inconsistency with the present disclosure

### FIELD OF THE INVENTION

The present invention relates to particles having a surface coating which is hydrophobic at least in sections, comprising carrier particles which are surface-coated at least in sections with a coating composition based on type A monomers, wherein the type A monomers are a substance of the structure,

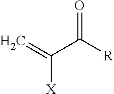

wherein R is selected from a group comprising OR¹, NR¹, NR¹R² and CN. The invention further relates to a method for producing such particles and a formed component comprising such particles.

### BACKGROUND OF THE INVENTION

A large number of particles are known from the prior art that can be used as fillers in composite materials, for example. Such fillers usually comprise a particulate inorganic carrier particle. Minerals such as quartz sand are often used.

To form composite materials, these particles are embedded in a matrix of an organic binder (e.g. polyester or acrylic), for example. Once the binder has hardened, the composite material is formed. Such composite materials can be used, for example, in kitchen sinks, sanitary products such as washbasins, shower trays, bathtubs, toilets and bidets. They are also used in furniture construction and in the building industry, for example as worktops, flooring or wall panelling.

In addition to these composite materials with mineral fillers, composite materials are also known in which synthetic fillers (e.g. ATH) are embedded in organic binders (e.g. known as “solid surface material”). It is also known that mixtures of different minerals can be used as fillers in a composite material (e.g. German patent application no. 10 2012 113 000.0: “Composite material and method for its production” of the same applicant Gebrüder Dorfner GmbH & Co. Kaolin-und Kristallquarzsand-Werke KG)

Polymers containing fillers have been produced and used on an industrial scale for many decades. For composite materials as described above, for example thermoplastics, thermosets or elastomers or mixtures of these three groups in various ratios are used as polymers. For example, acrylic-based filler-containing (e.g. quartz, ATH, etc.) flat formed components are known from the state of the art, which are produced using a thermoforming process to form a formed component that is used, for example, as a kitchen sink, but above all as a washbasin, shower tray or bathtub. In addition to quartz and ATH, it is also possible to use other fillers and additives.

Finally, the so-called mineral casting process (epoxy granite casting process), also known as the solid surface process, is also known from the state of the art. Here, polymers containing fillers are injected into the cast by means of pressure conveying and harden there, partly catalytically and partly thermally induced. The fillers used are mainly CaCO₃ and ATH, as well as additives and, if necessary, colouring components. Quartz sand or powder may also be included.

Most of the known processes have in common that the particulate components are mixed with a) a resin (syrup) of PMMA and MMA and cured under pressure and elevated temperature in formed components or b) cast with polyester in casting machines to form formed components and cured with the aid of curing additives. The polyester used in b) can optionally also contain a certain amount of MMA (methacrylic acid methyl ester, methyl methacrylate).

Efforts are currently being made to obtain both the polymers and fillers used increasingly from renewable raw materials.

Recently, organic fillers based on renewable raw materials have been increasingly used. These are, for example, nutshells or olive stones, fibres, pods, seeds or other plant components, which are used as flour or as particles ground to a specific grain size.

A disadvantage of many composite systems is that no sufficiently strong bond can be formed between the particles and the binder to fix the particles to the binder. In most cases, a particle in a composite material is therefore only spatially fixed by the hardened binder matrix (inorganic or organic) surrounding these particles; there is no actual (e.g. chemical) bond between the particle and the binder matrix. This can be explained by the fact that many filler particles have a hydrophilic surface, whereas many of the polymers used as binders are hydrophobic. They are therefore not bonded to the hydrophilic particle surface and act like predetermined breaking points under compressive or tensile stress, which is very disadvantageous.

In order to achieve better wetting by the binder as well as binding of the particles in the binder, successful attempts have been made to hydrophobise the surface of the particles. This could be achieved, for example, by means of silanisation, occasionally also siliconisation. Depending on the type of silane used and its functional group, better physical or chemical bonding to the surrounding binder is achieved. Mixed forms of both effects can also occur.

In recent years, the requirements for both composite materials and their base materials have changed considerably. In addition to the functionality and quality of one or more coated particles, attributes such as a lower-priced product as well as an energy-efficient and sustainable manufacturing process and the resulting formed component play a very important role, especially for those formed component manufacturers who want to offer a “green” product. These requirements usually affect the entire supply chain and therefore both the mineral filler and the composite material produced with it.

A surface coating as described above, in particular an inorganic coating, plus silanisation or siliconisation is neither cost-effective, energy-efficient nor sustainable. The introduction of such additional components also makes the already problematic recycling of composite materials even more difficult.

There is therefore a need for an alternative, low-cost surface coating for particulate fillers and a process for the energy-efficient application of such a surface coating to particles.

### SUMMARY OF THE INVENTION

This task is solved on the one hand by particles with a surface coating which is hydrophobic at least in sections, the particles comprising carrier particles which are surface-coated at least in sections with a coating composition based on monomers of type A (hereinafter also referred to as “A monomers”), where the monomers of type A are a substance of the structure

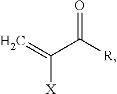

wherein R is selected from a group comprising OR¹, NR¹, NR¹R² and CN.

X is preferably H or a hydrocarbon chain, preferably an unbranched hydrocarbon chain and particularly preferably CH₃.

Independently of X, but preferably in addition to the preferred variants of X described above, R₁ and/or R₂ is preferably selected from a group comprising H, an unbranched hydrocarbon chain, in particular methyl, ethyl, n-butyl, branched hydrocarbon chain, in particular iso- and tert-butyl, cyclic hydrocarbon, polycyclic hydrocarbon, aromatic compound, unsaturated hydrocarbon, polyunsaturated hydrocarbon, (mono- or poly-) substituted hydrocarbon chain, (mono- or poly-) substituted cyclic hydrocarbon and (mono- or poly-) substituted aromatic compound. In the context of the present invention, the term hydrocarbon or hydrocarbon chain is to be understood in each case as the (alkyl) radicals corresponding to this hydrocarbon or this hydrocarbon chain. Analogously, this should also apply to aromatic compounds, so that a reference to an aromatic compound should also be understood as a disclosure of an aryl group based on this aromatic compound.

The average layer thickness of the coating composition arranged on a surface-modified particle is preferably ≤50 μm, preferably ≤30 μm, preferably ≤25 μm, more preferably ≤20 μm, further preferably ≤10 μm and most preferably ≤5 μm.

Furthermore, the task is solved by a formed component which comprises such surface-modified particles. These particles can, for example, be contained in the formed component as effect particles or as a filler.

A solution to the underlying problem thus lies in a formed component comprising one or more at least partially cured binders, as well as particles which have a hydrophobic surface coating at least in sections and which are at least partially embedded in the binder. It is envisaged that the particles comprise carrier particles which are surface-coated at least in sections with a coating composition based on type A monomers, wherein the type A monomers comprise a substance of the structure

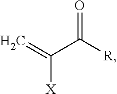

wherein R is selected from a group comprising OR¹, NR¹, NR¹R² and CN.

Preferably, a refractive index n of the hydrophobic surface coating at the wavelength 589 nm deviates by at most 0.1, preferably 0.08, more preferably 0.05, most preferably 0.03 from the refractive index n of the one binder or the several at least partially cured binders. This makes it possible to ensure that the colour of the carrier particles or which is applied to the carrier particles together with the surface coating and/or coating composition can also be perceived (at least almost) unchanged on the surface of the formed component. This makes it possible to predetermine the subsequent colour of a formed component (or its subsequent optical surface appearance) at an early stage before it is manufactured and to avoid the manufacture of a large number of formed components as test formed components.

In addition, the task is solved by a process for the production of surface-modified particles comprising the steps:
Providing of particulate carrier particles,
Providing a coating composition based on monomers of type A, wherein the monomers of type A are a substance of the structure

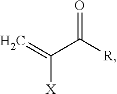

whereby
R is selected from a group comprising OR¹, NR¹, NR¹R² and CN,
mixing the carrier particles with the coating composition,
drying the mixture at a temperature above the minimum film formation temperature (MFT) of the polymerisable component during the application of shear energy to the mixture, and
linking of the polymerisable component on the surface to form a hydrophobic coating on the carrier particle.

An alternative, cheaper and more sustainable surface-coated granulate (hereinafter also referred to as filler) can thus be provided, which can be produced in an energy-efficient process.

Each of the process steps described in connection with the method can comprise several sub-steps. The sub-steps can also be identical. For example, a component can be supplied in several batches. A process can therefore be single or multi-stage.

Several process steps and/or their sub-steps can be carried out at different locations and/or times to other process steps and/or sub-steps.

Preferably, drying takes place at a temperature of ≤200° C., preferably ≤150° C., more preferably ≤100° C., most preferably ≤80° C. This minimises the energy required to produce these particles.

In particular, it is preferable that the drying is carried out by a warm fluid flow, for example air flow. The warm air flow can, for example, be a flow of waste heat air or waste gas. Alternatively or in addition, it has also proved advantageous to use a microwave or IR drying system or comparable energy-saving technologies for drying

In a preferred embodiment, a colouring agent and/or a pigment is added to the coating composition. This allows such a colouring component to be fixed to the surface of the carrier particle together with the binder. This enables special colour effects in composite materials, for example a natural stone-like appearance. It is thus possible to adjust the colour of the (coated) particles in the desired way and not only to provide a product in the form of a functional granulate, but also to produce a coloured granulate. In the context of the present invention, a functional granulate is understood to be a purely hydrophobic coating without colouring, whereas in the case of a “coloured granulate”, the coating composition is also used to fix colour and/or pigment to the carrier particle in addition to the hydrophobic coating in order to obtain a coloured filler.

In order to achieve uniform mixing and coating, it is preferable to avoid lump formation as far as possible. It has been shown to be a particularly suitable means of avoiding excessive lump formation that the carrier particles are heated and/or dried before mixing the carrier particles with the coating composition. It has been shown to be particularly advantageous to preferably heat the carrier particles to a temperature of 10-50° C., more preferably 15-30° C., most preferably 20-30° C., before mixing by means of a tempering device.

Preferably, the mixing of the coating composition and the carrier particles and possibly pigment takes place with a high shear energy input. The use of a forced mixer has proven to be particularly preferable for this purpose. This also has advantages in terms of avoiding the formation of lumps.

It has also been shown to be advantageous (as an alternative or in addition to the above measures) to use the coating composition in the form of an aqueous dispersion. Accordingly, the polymerisable component is preferably an aqueous dispersion of the polymerisable component, preferably formed from A monomers. Preferably, the polymerisable component formed from A monomers is emulsified in aqueous form. It has been shown that the use of such aqueous-emulsified dispersions is particularly advantageous, since their properties are comparatively easy to adjust over a wide range.

Preferably, the coating composition is present as a dispersion of a polymerisable component and/or substance. In particular, it is preferred that the polymerisable component comprises (at least partially) reactive A monomers and/or oligomers. Preferably, in the coating composition (preferably present as an aqueous dispersion), the proportion of the polymerisable component and/or the monomer of type A and/or its derivatives is >10% by mass, more preferably >20% by mass, most preferably >30% by mass. The aqueous polymer dispersion based on A monomers preferably has a polymer content in the range of 10-60 mass percent (Ma-%), preferably 20-50 Ma-%, particularly preferably at least 30 Ma-%. As a result, good processability and sufficiently strong bonding to the surface of the carrier particles can be achieved.

Unless otherwise stated in the context of the present invention, all percentages are to be understood as mass percent (Ma-%) in relation to the mass of the particles to be coated. Unless otherwise stated, mass percentages of the surface-coated particles are to be understood as related to a total mass of a formed component.

Preferably, the proportion of the polymerisable component in relation to the mass of the particles to be coated is <5 Ma-%, preferably <4 Ma-%, more preferably <3 Ma-% and particularly preferably <2 Ma-%, based on the particle mass.

Polymer dispersions based on A monomers, which have a comparatively high MFT (minimum film formation temperature), a low viscosity and a sufficiently high degree of linking and thus elasticity, have proven to be particularly preferable.

In a coating composition present as an aqueous dispersion, its minimum film-forming temperature is preferably >15° C., more preferably >18° C., more preferably >20° C., most preferably >25° C. This ensures that a homogeneous wetting of the surface of the carrier particles with the coating composition can be achieved.

Preferably, the polymerisable component an MFT of at least 10° C., preferably ≥15° C., more preferably ≥20° C. and most preferably ≥25° C. This prevents premature, uncontrolled drying.

A viscosity of the coating composition in the form of an aqueous dispersion of <700 mPas, preferably <500 mPas, most preferably <300 mPas, has also been shown to be advantageous for homogeneous wetting of the surface of the carrier particles with the coating composition. Preferably, the viscosity of the coating composition is <5000 mPas, preferably <2000 mPas, more preferably <1000 mPas, more preferably <500 mPas and most preferably <300 mPas.

Such a polymer dispersion based on A monomers can be easily applied to the particles (also known as granules) and dried due to its very low viscosity and polar character.

If the coating composition comprises a polymer or oligomer based on A monomers as a polymerisable component, it is preferred that this coating composition (or the polymer or oligomer dispersion and/or the polymerisable component) is self-linking. In addition, the handling of the coating composition and in particular the process control can be simplified by the fact that the coating composition present as an aqueous dispersion is self-linking.

Optionally, the carrier particles are first mixed with the coating composition and then with the pigment. However, it is also possible to coat the carrier particles first with the pigment and then with the coating composition. Finally, there is also the option of premixing the coating composition and/or the polymerisable component with the pigment and then mixing both together with the particles.

In order to introduce the required shear energy, mixing over a period of preferably 2-30 minutes, preferably 3-20 minutes, more preferably 4-10 minutes and particularly preferably around 5 minutes has proven to be advantageous. Optionally, the mixing process can also be supported mechanically with agitators.

Drying is then preferably carried out on a drying belt, which is preferably equipped with a vibrating conveyor. During the transport of the particles on the drying belt, an air flow of the above-mentioned temperature, for example ≤80° C., is preferably guided over the drying belt.

Preferably, water is discharged in this step, preferably completely.

The coating composition or the polymerisable component of the coating composition is then linked. Depending on the materials used, the progress of the linking can be monitored by detecting condensation products, for example split off ammonia, alcohols or CO₂.

Preferably, the drying and linking of the polymerisable component is carried out at least partially, preferably completely, at different locations and/or at different times.

In order to avoid destroying the surface coating as far as possible, it is preferable to minimise the input of shear energy from the moment linking begins.

The proposed local and/or temporal separation of drying and linking means that drying can take place with shear energy input, which is advantageous for the drying time and also the energy balance, whereas linking can take place separately without or with only low shear energy input, which is advantageous for a stable surface coating.

Preferably, this is followed by protective screening and preparation for further processing (possibly at different locations and/or at different times).

A particle produced by such a process is suitable for a wide range of applications. It has a hydrophobic surface coating and can form a strong bond with a binder, for example a binder matrix, in particular a surrounding acrylate-containing binder. It has also been shown that particles coated in this way also achieve advantageous results in a surrounding matrix of polyester resin, which are comparable to silanised particles. The hydrophobisation that is necessary or at least advantageous for many applications can therefore be achieved without having to handle expensive silanes that have to be applied using complex processes.

Inorganic minerals, recycled granulates and organic, renewable raw material granulates have proven to be particularly suitable as carrier particles.

If the carrier particles are mineral granules, they are preferably selected from a group comprising quartz sand, calcium carbonate and feldspar. Preferred recycled granulates are broken glass, broken granite, waste sand and foundry sand (individually or as a mixture).

Preferably, a carrier particle is selected from a group comprising oxides, silicates, phosphates, carbonates, sulphates, anhydrites, glasses, as well as ceramics and amorphous materials.

A carrier particle can originate from a natural source, be manufactured specifically or be obtained from a recycling process. A filler obtained from a recycling process is preferably a recycled ceramic, a recycled porcelain or a recycled glass.

Further examples of preferred carrier particles are (Na, K, Ca, mixed) feldspars, limestone, marble, dolomite, BaSO₄, talc, MgCO₃, wollastonite, kaolin, soda-lime glass, borosilicate glass, quartz glass (generally) (colourless or coloured, transparent or opaque), ceramics, porcelain, mullite, corundum, apatite, mussel shells, aluminium hydroxide, magnesium hydroxide, zirconium oxide, perlite, pumice. These can be used alone or mixed with another carrier particle of the above-mentioned group or mixed with another carrier particle.

Other alternative or additional recycling materials that can be used are shredded polymer-bound kitchen sinks, washbasins, shower trays or bathtubs based on e.g. ATH or carbonates as described above. The polymer used in these materials is e.g. polyester or acrylic based. A recycled material can also be, for example, recycled foundry sand or recycled sands. Recycling materials based on organic polymers can also be used, e.g. PET pellets, rubber pellets, EPDM pellets, WPC pellets and many more.

In a further embodiment, it is preferred that the carrier particles used contain a proportion of crystalline silica of <0.1 ma-%, i.e. are virtually free of quartz sand, quartz flour or cristobalite and tridymite, and that the alternative materials used also contain a proportion of crystalline silica of <0.1 ma-%, either alone or in total.

As an alternative to quartz, other materials are preferably used in a certain way to ensure the necessary abrasion resistance The abrasion resistance according to the Taber Abrasion Test (DIN 14688 or DIN 13310) is usually ≤35 mg/100 cycles, preferably ≤30 mg/100 cycles, more preferably ≤25 mg/100 cycles and particularly preferably ≤20 mg/100 cycles.

In a preferred embodiment, a carrier particle based on renewable raw materials is used alternatively or additionally. Preferably, such a filler is selected from a group comprising nutshells, olive pits, plum stones, hemp and caraway press cake, fibres, husks, seeds or other plant constituents. Preferably, these are used alone or in combination with one or more other carrier particles based on renewable raw materials. Preferably, at least one of these carrier particles is present as flour or as particles ground to a specific grain size.

Preferably, the (uncoated carrier) particles have an average size (d₅₀, preferably measured by sieve analysis or laser diffraction) in the range of 5 μm-15 mm, preferably 10 μm-10 mm, further preferably 20 μm-8 mm and most preferably 50 μm-2 mm. Unless otherwise stated in the context of the present invention, all particle size specifications are to be understood as mean particle size d₅₀ (sieve analysis or laser diffraction). Whether the mean particle size is to be determined by sieve analysis or laser diffraction depends essentially on the expected mean particle size d₅₀: A person skilled in the art knows that sieve analysis is suitable for determining the size of larger average grain sizes, whereas laser diffraction is suitable for determining the size of smaller average grain sizes.

Furthermore, the task is solved by a formed component which comprises such surface-modified particles. These particles can, for example, be contained in the formed component as effect particles or as a filler. Insofar as reference is made in the following to effect particles or a filler of a formed component or a mass for producing a formed component, this should be understood to mean effect particles or a filler which comprise at least one type of the particles described above.

A formed component is provided comprising one or more at least partially cured binders, as well as particles which have a hydrophobic surface coating at least in sections and which are at least partially embedded in the binder. It is envisaged that the particles comprise carrier particles which are surface-coated at least in sections with a coating composition based on type A monomers, wherein the type A monomers comprise a substance of the structure

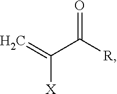

wherein R is selected from a group comprising OR¹, NR¹, NR¹R² and CN.

Preferably, a refractive index n of the hydrophobic surface coating at the wavelength 589 nm deviates by at most 0.1, preferably 0.08, more preferably 0.05, most preferably 0.03 from the refractive index n of the one binder or the several at least partially cured binders. This makes it possible to ensure that the colour of the carrier particles or which is applied to the carrier particles together with the surface coating and/or coating composition can also be perceived (at least almost) unchanged on the surface of the formed component. This makes it possible to predetermine the subsequent colour of a formed component (or its subsequent optical surface appearance) at an early stage before it is manufactured and to avoid the manufacture of a large number of formed components as test formed components.

The filler may comprise several components. As explained above, the filler comprises at least one type of the particles described above. If the filler comprises several components, a ratio of these components in the filler to each other can vary within a comparatively wide range and thus be adapted to the properties expected of the formed component. For example, a preferred filler comprising two components, a first and a second component, may have a ratio of the first component to the second component in the range of 1:99-99:1. A ratio of the first to the second component in the range of 50:50-98:2, more preferably 60:40-95:5 and particularly preferably 75:25-90:10, has proven to be preferred. Preferably, in the case of a filler comprising three, a first, a second and a third component, a ratio of the first component to the second component to the third component can be in the range from 1:1:98 to 1:98:1 to 98:1:1, it being expressly pointed out that the proportions of the three components can be varied independently of one another in the above-mentioned ratio and that it is not absolutely necessary for two components to be present in a ratio of 1:1. However, a ratio of essentially 1:1:1 is preferred.

According to a preferred embodiment, the proportion of the individual filler components in relation to the total filler is in the range of 0.01-99.99% by weight, preferably 0.01-90% by weight, preferably 0.01-80% by weight, more preferably 0.01-70% by weight, particularly preferably 0.01-60% by weight, especially preferably 0.01-50% by weight and particularly preferably 0.01-40% by weight. By adding a filler component with a respective percentage by weight or mass relative to the weight or mass of the entire filler, the properties of the resulting filler mixture and thus also a property of the formed component produced with it can be advantageously adjusted at least within a certain range.

In a formed component as described above, the particles described above (for example as a filler) are fixed in a binder matrix after polymerisation of the binder, so that the formed component retains its shape permanently. Preferably, a formed component is selected from a group comprising kitchen sinks, kitchen worktops, washbasins, shower trays and cubicles, toilets, bathtubs, panels, floor coverings, furniture parts, partition walls and tiles.

Such a formed component can also be post-processed, e.g. chemically and/or physically as well as mechanically. Preferably, one of the post-processing steps is selected from a group comprising annealing, irradiation (UV, IR . . . ), cutting, drilling, milling, bending, sawing, grinding and polishing.

In the case of kitchen sinks, for example, the formed component is preferably given the desired shape by filling the composition into a negative mould and hardening it (at least partially). As mentioned above, such formed components are used in many applications. Of particular importance are applications in the kitchen and sanitary sector, for example in the form of washbasins or sinks, shower trays and bathtubs. Formed components of this type have the advantage that they are virtually unlimited in their geometry due to the small size of the filler particles and the variable arrangement of the filler particles in relation to each other. This means that washbasins, sinks, shower trays and bathtubs can also be produced in geometric shapes that cannot be realised using other techniques. The surface coating of the particles makes new optical effects possible and particularly clear colour impressions can be achieved.

Preferably, a formed component can be produced using a thermoforming, gelcoat or mineral casting process, regardless of the type of formed component and its use.

Preferably, such a formed component, which could be used for kitchen sinks, for example, has a filler content of at least 70-75% by weight.

### BRIEF DESCRIPTION OF THE DRAWINGS

Further advantages, objectives and features of the present invention are explained with reference to the following examples and the description of the accompanying figures. It shows:

FIGS. 1a-1c show microscopic images of coated particles in an embodiment of the present invention.

### DETAILED DESCRIPTION OF THE INVENTION

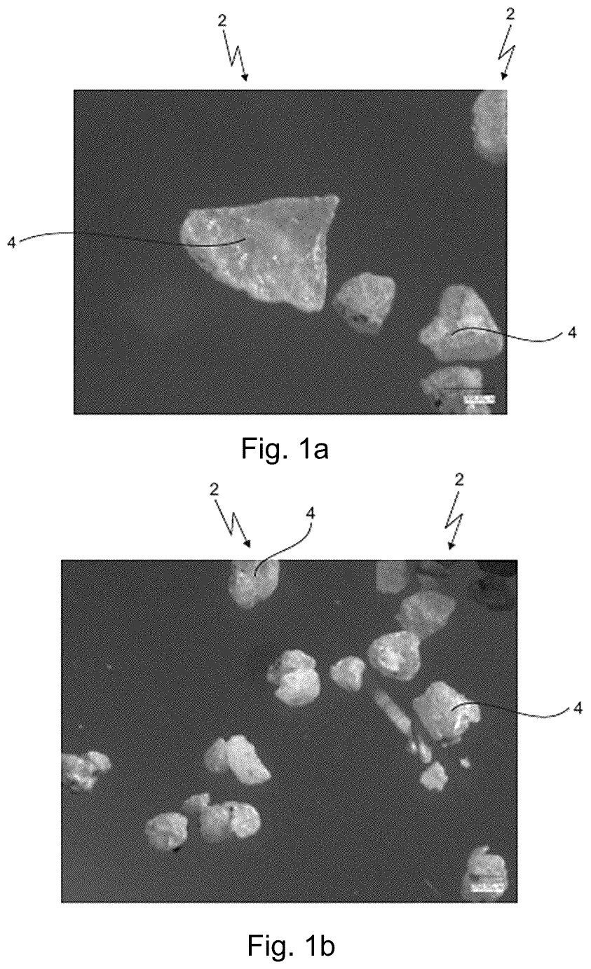

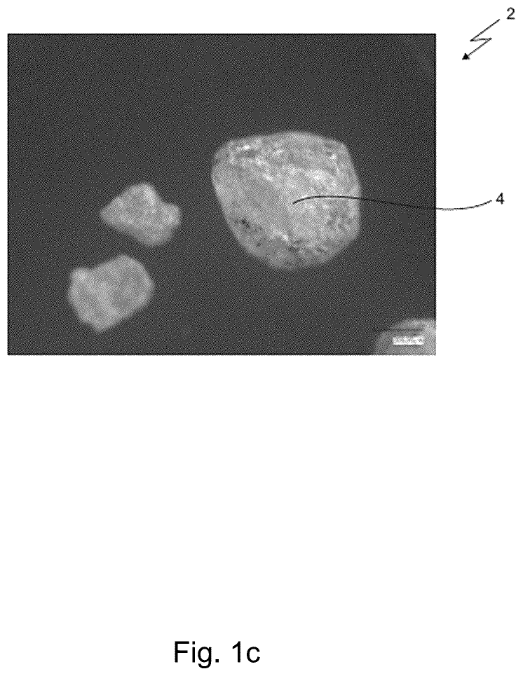

FIGS. 1a-1c show microscopic images of coated particles. Quartz was used as the carrier particle. The quartz particles were provided with a grey coating. The images show the uniform coating of the carrier particles with the coating composition. These coated particles are very homogeneously coated and have a uniform colour.

For the images shown in FIGS. 1a-1c, filler particles were placed on a microscope slide and separated. The particles were optically examined under a Keyence VK-X laser microscope at various magnifications of 5×, 10×, 20× and 50× in order to be able to represent and visualise the properties of the surfaces. The bar shown at the bottom right of the FIGURES represents a length of 200 μm as a reference.

The particles shown in FIGS. 1a-1c were taken from a sample obtained by coating 400 kg of quartz particles with a grain size between 0.1-0.5 mm with a grey coating composition. The coating composition comprises 4.8 kg of white pigment, 80 g of blue pigment, 480 g of black pigment and 4.8 kg of binder based on type A monomers.

The coating composition was fixed to the surface of the quartz particles at a temperature of 100° C. It has been shown that it is advantageous to preheat the quartz particles to a temperature of around 20° C. before mixing them with the coating composition. If the quartz particles were used at the (ambient) temperature of around 10° C., adhesion to the stirring tool and clumping of the product occurred. In contrast, no influence of the coating composition, which was also used at a temperature of around 10° C., was recognised.

The coated particles obtained in this way were analysed for their suitability for use in a casting compound to produce a composite material. A key criterion for this suitability is the rheological properties, which can provide information in particular on the layer thicknesses a composite material may have, how complex and fine the composite material geometry may be and whether complications are to be expected when filling the casting compound into a casting mould.

To measure the rheological properties, 100 g of the coated particles obtained as described above were mixed with 42.8 g of polyester resin. After a mixing time of about 1 min, the flowable material was transferred to a measuring cylinder, which was then inserted into the measuring device of the Anton Paar MC 302 rheometer. The viscosity was measured at 25° C. using a cylinder-spindle method. The viscosity was measured as a function of the shear rate (0-200 1/s).

Conventionally coloured quartz particles of the same (carrier) particle size (0.1-0.5 mm) and colour (grey) were used as a comparison to the coated particles formed according to one embodiment of the present invention. These reference particles were measured in the same way as described above. The results of the comparative investigation of the rheological properties of two samples each of the reference particles and the particles according to the invention are shown in Table 1.

TABLE 1
Comparison of rheological properties

| | Initial | Reverse | Final |
|---|---|---|---|
| | viscosity | viscosity | viscosity |
| Designation | [Pa*s] | [Pa*s] | [Pa*s] |
| Comparative sample 1 | 41.5 | 7.0 | 29.0 |
| Comparative sample 2 | 40.0 | 7.0 | 28.5 |
| Sample 1 with binder | 51.0 | 7.0 | 35.0 |
| based on A | | | |
| Sample 2 with binder | 48.5 | 7.0 | 37.5 |
| based on A | | | |

As can be seen in Table 1, the rheological properties of the measured samples are in the same size range, even if the initial viscosity of the samples with the particles according to the invention is increased by about 10 Pas compared to the reference samples. The difference in the final viscosity between the samples with the particles according to the invention compared to the reference samples is even significantly lower and the reverse viscosity is even at the same value for all measured samples, namely 7.0 Pa*s. These results show that the particles according to the invention are suitable for use in a moulding compound. It is assumed that by adjusting some parameters, the rheological properties of the particles according to the invention could be even more similar to those of the reference samples. For example, more gentle drying could be advantageous. However, the results of investigations in this regard are not yet available.

When testing a casting compound with particles according to the invention of an embodiment with a grey coating of the carrier particles, it was even found that such a casting compound even has improved properties with an otherwise identical formulation.

For example, it was found that test specimens performed significantly better in terms of their brightening behaviour according to the CIE Lab colour space when the thermal shock behaviour was tested in accordance with DIN EN 13310. The brightening was lower and therefore better than when using a binder known from the state of the art. The corresponding results are shown in Tables 2a and 2b. In particular, it can be seen that the differenceΔ of the L value drops significantly from 6.8 for the test specimen with known particles to around 4.2 for the test specimen with particles according to the invention.

TABLE 2a
Brightening behaviour according to DIN EN 13310 of a test
specimen with particles according to the invention

| | Test specimen | Test specimen | |
|---|---|---|---|
| Colour | 1 (invented) | 1 (invented) | |
| values (color) | before | according to | Δ |
| L | 63.87 | 68.06 | 4.19 |
| a | 0.45 | −0.11 | 0.56 |
| b | 0.84 | 4.09 | 3.25 |

TABLE 2b
Brightening behaviour according to DIN EN 13310
of a test specimen with known particles

| Colour | Comparison 1 (known) | Comparison 1 (known) | |
|---|---|---|---|
| values (color) | before | according to | Δ |
| L | 56.47 | 63.27 | 6.8 |
| a | 1.73 | 0.66 | 1.07 |
| b | 3.44 | 4.88 | 1.44 |

It was also found that the settling behaviour in the matrix is significantly more stabilised compared to casting compounds with particles known from the state of the art. This leads to a more even distribution of the particles in the matrix, which could be explained by a reduced settling behaviour. Accordingly, the backs of formed components made from this material have a more visually appealing surface, particularly with regard to a more even distribution of the particles visible on the surface.

When using casting compounds with particles according to the invention, an equivalent flow behaviour was observed compared to casting compounds with particles coated with a conventional binder system (inorganic or organic). Accordingly, existing systems are already suitable for the use and processing of casting compounds with particles according to the invention, in most cases even without retrofitting.

Studies with different carrier particles and different particle sizes of the carrier particles have shown that a wide variety of minerals can be converted into the particles according to the invention with comparatively short mixing times (for example ≤1 min). The hydrophobic surface coating based on type A monomers is suitable for coating feldspar-containing sands and very fine particles (e.g. sieving <315 μm or <200 μm), among other things. For very fine particles in particular, however, the amount of binder used (in percent by mass in relation to the mass of the carrier particles) had to be increased, but this is due in particular to the greater surface-to-volume ratio (and thus also surface-to-mass ratio) of the finer particles. In all cases, a very good, uniform coating was achieved, which has a very homogeneous and even visual appearance.

The suitability of a coating system based on type A monomers for coating particles of different grain sizes was also confirmed by the following comparisons. Quartz sands of different grain sizes were used as carrier particles for the formulations shown in Table 3 and the colour values given in the table below were measured.

TABLE 3
Formulations and colour values for black coated particles

| | Test particle | Test particle |
|---|---|---|
| | black 1 | black 2 |
| Component/ | | |
| measured value | | |
| Carrier particles | 100 kg quartz | 100 kg quartz |
| | sand (0.1-0.5 mm) | sand (0.3-0.8 mm) |
| Binding agent | 1200 g binder (based | 1200 g binder (based |
| | on A-type monomers) | on A-type monomers) |
| Solvent | 500 g water | 500 g water |
| Colourant | 500 g black pigment | 500 g black pigment |
| Colour L*a*b* | | |
| L*: | 38.1 | 37.3 |
| a*: | 0.1 | 0.1 |
| b*: | 0.4 | 0.3 |

As can be seen in Table 3, a uniform coating was achieved even with different particle sizes but otherwise identical formulations. The colour values measured for the two test particles are extremely similar. The optical colour impression is a very homogeneous black.

Test specimens of the test particles shown in Table 3 were moulded using a polyester resin. For test specimen 1, the test particles 2 were moulded into the polyester resin as the only component of a filler composition. For test specimen 2, on the other hand, test particles 2 were used as a component of a filler composition that also contained test particles 1, a black colourant and quartz powder. The formulations of the casting compounds and the colour values measured for the test specimens obtained from them are listed in Table 4 below.

TABLE 4

| | Test specimen 3 | Test specimen 4 |
|---|---|---|
| Filler composition | 100% test particles | 77% Test particles black 2 |
| | black 2 | 5% test particles black 1 |
| | | 8% black coloured sand |
| | | 10% quartz flour |
| Recipe | | |
| | 70 g Filler composition | |
| | 30 g polyester resin | |
| | 0.6 g polymerisation initiator | |
| | (methyl ethyl ketone peroxide) | |
| Colour L*a*b* | | |
| L*: | 26.2 | 26.1 |
| a*: | 0.1 | 0.1 |
| b*: | −0.4 | −0.4 |

As can be seen in Table 4, the colour values measured on the two test specimens differ only very slightly from each other. It is also noteworthy that the colour of the test specimens differs only slightly from that of the test particles. This has a significant advantage in the production of formed components from casting compounds, as the colour of the formed component can be predetermined almost exactly before it is produced by selecting the correspondingly coloured coated particles. This reduces the number of test bodies that have to be produced before a large series of formed components is manufactured in order to be able to adjust the visual appearance of the formed components precisely to the requirements.

Test specimens 3 and 4 were also subjected to a test that detects colour changes or colour fading after treatment with hot water. For this purpose, the test specimens were firmly clamped in a container, which was then filled with deionised water so that the test specimens were completely surrounded by water at all times. A temperature control device raises the temperature of the water to 90° C. within 30 minutes. Once this target temperature has been reached, the water is kept at 90° C. for 8 hours so that each test specimen remains exposed to the hot water for this time. The capacity of the built-in circulation pump is 5 litres per minute, so that a constant temperature and uniform temperature distribution within the container can be guaranteed over the test period.

After the specified treatment time has elapsed, the hot water is drained off and the test specimens are cooled down. The test specimens are then measured colorimetrically. The results for test specimen 1 are shown in Table 5.

TABLE 5
Comparison of the colour values of test specimen
1 before and after hot water treatment

| | CIE-Lab | CIE-Lab | | |
|---|---|---|---|---|
| | before test | after test | Δ-Values | Δ E-value |
| Test | L*: 26.18 | L*: 26.07 | ΔL*: 0.11 | 0.5 |
| specimen 1 | a*: 0.1 | a*: 0.07 | Δa*: 0.03 | |
| | b*: −0.4 | b*: 0.08 | Δb*: 0.48 | |

As can be seen from the values in Table 5, the particles according to the invention not only provided a very homogeneous black, but also improved the processing of fillers with these particles. These particles harmonise very well with aqueous suspensions and water and can be processed on known machines. In addition, the tests on test specimens show extremely good values for the colour black with regard to brightening through prolonged contact with hot water. The ΔE value of just 0.5 measured on the sample test specimen 1 is well below the limit of 0.8 ΔE, which is only undercut by the group of the best composites in this test. Typical values for composite materials in this test are usually in a range of up to 3 ΔE.

The applicant reserves the right to claim all features disclosed in the application documents as being essential to the invention, provided that they are new compared to the prior art, either individually or in combination. It should also be noted that the individual FIGURES also describe features which may be advantageous in themselves. The skilled person immediately recognises that a particular feature described in a FIGURE can also be advantageous without the adoption of further features from this FIGURE. Furthermore, the skilled person recognises that advantages can also result from a combination of several features shown in individual FIGURES or in different FIGURES.

The applicant points out that all features disclosed in relation to the particles and/or the formed component also represent preferred embodiments of the method described above. Similarly, all features disclosed in connection with the method are also intended to specify the particles and/or the formed component.

### LIST OF REFERENCE SYMBOLS

2 Particles,
4 Surface layer, near-surface layer,

1.-15. (canceled)

16. A particle with an at least partially hydrophobic surface coating, comprising a carrier particle which is at least partially surface-coated with a coating composition based on a type A monomer, wherein the type A monomer comprises a substance having the structure 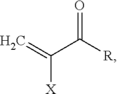
wherein
R is selected from a group comprising OR¹, NR¹, NR¹R² and CN.

17. The particle of claim 16, wherein X is H or a hydrocarbon chain.

18. The particle of claim 16, wherein X is CH₃.

19. The particle of claim 16, wherein R¹ and/or R² is selected from a group consisting of H, an unbranched hydrocarbon chain, branched hydrocarbon chain, cyclic hydrocarbon, polycyclic hydrocarbon, aromatic, unsaturated hydrocarbon, polyunsaturated hydrocarbon, mono- or poly-substituted hydrocarbon chain, mono- or poly-substituted cyclic hydrocarbon, mono- or poly-substituted aromatic, and combinations thereof.

20. The particle of claim 16, wherein an average layer thickness of the coating composition arranged on a surface-modified particle is ≤50 μm.

21. The particle of claim 16, wherein an average layer thickness of the coating composition arranged on a surface-modified particle is ≤5 μm.

22. The particle of claim 16, wherein the carrier particles have an average particle size (d₅₀), as measured using laser diffraction and/or sieve analysis, between 10 μm-5 mm.

23. The particle of claim 16, wherein the carrier particle is selected from a group consisting of a mineral granulate, a recycled granulate, and a renewable raw material granulate.

24. The particle of claim 16 comprising a pigment which is bound on a surface of the carrier particle, wherein a mass fraction of the pigment relative to the mass of the particle is ≤10%.

25. The particle of claim 16 comprising a pigment which is bound on a surface of the carrier particle, wherein a mass fraction of the pigment relative to the mass of the particle is between 0.1%-2%.

26. A method for producing surface-modified particles comprising the steps of:
a) providing particulate carrier particles,
b) providing a coating composition based on monomers of type A, wherein the monomers of type A are a substance having the structure 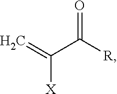
wherein
R is selected from a group comprising OR¹, NR¹, NR¹R² and CN,
c) mixing the carrier particles with the coating composition,
d) drying of the mixture at a temperature above a minimum film formation temperature (MFT) of the polymerisable component during application of shear energy to the mixture, and
e) linking of the polymerisable component on the surface to form a hydrophobic coating on the carrier particle.

27. The method of claim 26, wherein the drying step takes place at a temperature of ≤80° C.

28. The method of claim 26, wherein the drying is carried out by a warm fluid flow, a microwave, or an IR drying system.

29. The method of claim 26, wherein the drying and the linking of the polymerisable component are carried out at least partially at different locations and/or at different times.

30. The method of claim 26, wherein the carrier particles are heated and/or dried before mixing the carrier particles with the coating composition.

31. The method of claim 26, wherein the carrier particles are heated to a temperature of 10° C.-50° C. by means of a tempering device before mixing.

32. The method of claim 26, wherein the coating composition is an aqueous dispersion, wherein,
a proportion of the monomer of type A and/or its derivatives in the coating composition is >20 percent by mass,
a minimum film-forming temperature of the coating composition is >15° C.,
a viscosity of the coating composition is <700 mPas, and/or
the coating composition is self-linking.

33. A formed component comprising one or more at least partially cured binders, and particles which have a hydrophobic surface coating at least in sections and which are at least partially embedded in the binder, wherein the particles comprise carrier particles which are surface-coated at least in sections with a coating composition based on type A monomers, the type A monomers comprising a substance having the structure 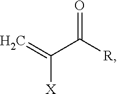
wherein
R is selected from a group comprising OR¹, NR¹, NR¹R² and CN.

34. The formed component according to claim 33, wherein a refractive index n of the hydrophobic surface coating at the wavelength 589 nm deviates by at most 0.1 from a refractive index n of the one binder or the plurality of at least partially cured binders.

35. The formed component according to claim 33, wherein a refractive index n of the hydrophobic surface coating at the wavelength 589 nm deviates by at most 0.03 from a refractive index n of the one binder or the plurality of at least partially cured binders.
